(19) United States
(12) Patent Application Publication
(10) Pub. No.: US 2016/0061381 A1
(43) Pub. Date: Mar. 3, 2016

(54) Pressure Vessels, Design and Method of Manufacturing Using Additive Printing

(71) Applicant: Igor K. Kotliar, New York, NY (US)

(72) Inventor: Igor K. Kotliar, New York, NY (US)

(21) Appl. No.: 14/215,107

(22) Filed: Mar. 17, 2014

(51) Int. Cl. F17C 1/08; F15D 1/04; F16L 9/04; F16L 9/10; B23K 26/00; B29C 67/00; B22F 3/105; B23K 15/00; B23K 26/342; F17C 13/04; F16L 9/12

(52) U.S. Cl. CPC F17C 1/08; F17C 13/04; F15D 1/04; F16L 9/04; F16L 9/10; F16L 9/12; B29C 67/0077; B22F 3/1055; B23K 15/0086; B23K 26/342; B23K 26/0006; B23K 15/0093; F17C 2203/012; F17C 2203/0663; F17C 2205/0323; F17C 2209/22; F17C 2260/01; F17C 2270/0142; B29K 2101/12

(57) ABSTRACT

Method and design of a pressure vessel having an internal supportive structure that reduces pressure forces applied to the external shell of the vessel by distributing such forces via internal bonds mostly connected to a central supporting element. The method and design allow making much lighter and stronger pressure vessels and containers using additive manufacturing technology, known as 3D printing.

### BACKGROUND OF THE INVENTION

1. Field of the Invention

This invention is in the field of pressure vessels such as those that are used in a variety of applications worldwide. These applications include industrial compressed air receivers, domestic hot water storage tanks, diving cylinders, recompression chambers, distillation towers, pressure reactors, autoclaves, and many other vessels in mining operations, oil refineries, petrochemical plants and nuclear reactor vessels.

Other applications include submarine and space ship habitats, aircraft pressurized systems, pressurized pneumatic and hydraulic reservoirs, rail vehicle airbrake reservoirs, road vehicle airbrake reservoirs, and storage vessels for liquefied gases such as ammonia, chlorine, propane and butane, and modern vehicles using compressed gases for their engines.

By way of only one (non-limiting example), fire suppression systems require high-pressure storage containers (also called bottles or cylinders), hundreds of thousands of which are being installed every year worldwide.

Many known pressure vessels are made of steel, either in a cylindrical or spherical shape, but some mechanical properties of steel, achieved by rolling or forging, could be adversely affected by welding, which is necessary to make a sealed vessel and leads to an increased wall thickness and overall weight of such vessels.

Some known pressure vessels are made of composite materials, such as a filament wound composite using carbon fiber held in place with a polymer. Due to the very high tensile strength of carbon fiber, these vessels can be very light, but are much more difficult to manufacture and require much more human labor.

The present invention introduces a method of manufacturing a new type of pressure vessel, and various design configurations of such pressure vessels using additive manufacturing technology, better known as 3D Printing, to provide:
pressure vessels that are lighter and cheaper than those currently known;
pressure vessels having unique internal supportive structure;
pressure vessels that can withstand much higher pressures than those heretofore known;
pressure vessels that can be made automatically in one 3D printing process; and
pressure vessels that can be made economically and in an ecology-friendly manner without any waste in material.

The term “vessel” as used in this specification means any enclosed container, cylinder, bottle, tank, pipeline, inhabited vehicles (spacecraft, undersea research vessels, etc.) or any other enclosed structure capable of maintaining an interior pressure which is different from the pressure on the outside thereof. Vessels and inhabited containers having increased outside pressure apply to this invention as well.

2. Description of the Related Art

One of the earliest early efforts to design a vessel (tank) capable of withstanding high pressures up to 10,000 psi (69 MPa) was made in 1919. The result was a 6-inch (150 mm) diameter tank spirally-wound with two layers of high-tensile-strength steel wire to prevent sidewall rupture, having end caps longitudinally reinforced with lengthwise high-tensile rods.

U.S. Pat. No. 4,505,417, to Makarov, et al., describes a mill for manufacturing bodies of multilayer high-pressure vessels comprising rotators to rotate the body of the vessel, which has its butt-end portions secured therein. The body of the vessel is surrounded by a portal capable of moving along the body of the vessel for winding a steel strip around the vessel body.

U.S. Pat. No. 5,419,416, to Miyashita, et al., describes an energy absorber having a fiber-reinforced composite structure for receiving impact energy. The absorber has a body formed of a fiber-reinforced composite material with a hollow cylindrical shape and having a plurality of portions so that the thickness of the body gradually increases in at least two stages in an axial direction.

U.S. Pat. No. 8,557,185, to Schulmyer, et al., describes an external pressure vessel and at least one insert basket in the pressure vessel.

U.S. Pat. No. 8,540,876, to Poklop, et al., describes a multi-tube pressure vessel, however the focus of this invention is a permeate adapter.

A seemingly close design idea was presented in U.S. Pat. No. 7,963,400, to Stolarik, et al. This patent describes a thermoplastic distributor plate for a composite pressure vessel having a central opening and radial slits, however, the plate is useful only for the purpose of swirling the fluid through the disk from the bottom side to the top side around the opening for use in a water treatment apparatus. Moreover, in this case the disks should only “have a thickness sufficient to support water treatment media without deforming”—column 5, line 1. So, practically, in this case the outside wall of the vessel was holding and preventing the disk from deforming or destruction, which is the exact opposite from the present invention.

Finally, all previous inventions were focused mainly on reinforcing the walls of a vessel using different techniques and materials, from high tensile steel strips to composite materials. Nobody was actually thinking about reinforcing the vessel walls from the inside by providing an internal supportive structure that allows the considerable reduction of the pressure load on the walls of a vessel by transmitting such a load to the opposite part of the wall via the internal supportive structure, thereby distributing the pressure applied to the wall. Furthermore, no one thought about the possibility of making pressure vessels using a 3D printing process, which allows for the production of a whole vessel in one process and without use of human intervention and, most importantly, without waste materials.

The present invention therefore provides an improved method for manufacturing a pressure vessel, and a unique design of a pressure vessel that has improved performance and cost compared to known pressure vessels and methods for making them.

### DEFINITIONS

In the specification, the following terms have the meanings ascribed thereto:

Additive manufacturing or 3D printing is a process of making a three-dimensional solid object of virtually any shape from a digital model. 3D printing is achieved using an additive process, where successive layers of material are laid down in different shapes. 3D printing is also considered distinct from traditional machining techniques, which mostly rely on the removal of material by methods such as cutting or drilling (subtractive processes). Additive manufacturing employs different manufacturing technologies that can produce custom parts by accurately “printing” layer upon layer of material, including, but not limited to, plastics or metal, until a 3D form is created.

Bond—a device providing strong and solid connection between the wall or shell of a Pressure Vessel and/or a Central Supporting Element and having any shape including but not limited to the shape of spokes, strings, needles, chains, disks, plates, rods, screw-shaped and complex profiled structures, tubes, polyhedrons, cellular and Honeycomb-like structures and other rigid ties that allow the distribution and reduction of pressure forces applied on the walls or shell of a Vessel.

Central Internal supportive Element—an enclosed structure inside of a Pressure Vessel having its own internal enclosed space or cavity that communicates with the interior of the Pressure Vessel via one or more holes or other openings, and communicates with the environment outside of the Pressure Vessel via a Filling and/or Release device, such as a valve, when such has been initiated during filling or release of a fluid stored inside of the Vessel or other entry or exit (for human occupied containers). The Central supporting element, situated in any part of the Pressure Vessel, has a solid connection to the outer shell of the Pressure Vessel via Bonds and may have any geometrical shape, including but not limited to a round tube, sphere, Honeycomb-like cell or polyhedron-shaped cell or rod.

Honeycomb-like internal supportive structure—a Bond structure consisting of cells of any geometrical shape, whether enclosed or open, and including, but not limited to, any shape from a round tube to a polyhedron, having an internal space that communicates, directly or indirectly, with internal spaces of all other cells and the internal cavity of the Central Supporting Element, which in this case can be just another cell that distinguishes from all other cells in the structure by having direct communication with a Filling and/or Release device. Such a structure builds firm bonds or connections between the walls or Shell of the Pressure Vessel and the Central supporting element for distribution and reducing of tensile forces and the pressure load on the walls or shell of a Vessel.

Internal supportive structure—a structure that provides strong, solid connection between the walls (or shell) of a Pressure Vessel and the Internal Supportive Element via Bonds for distributing and reducing the pressure load on the walls or shell of a Vessel.

Pressure Vessel—an enclosed container, bottle, cylinder, pressurized pipe and any other enclosed structure designed to hold and/or transport gases, liquids and/or other fluids at a pressure substantially different from the ambient pressure, whether the internal pressure is higher or lower than ambient. This definition applies also to underwater, aerial and space vehicles and structures, both inhabited and industrial.

Filling device—a valve, regulator, tap or any other device, assembly or structure that allows filling and refilling of a Pressure Vessel with a fluid; in most cases such a device is used for both filling the Pressure Vessel with a fluid and for releasing the fluid therefrom. A Filling Device is normally situated in the end cap (or “head”) of a Pressure Vessel. For inhabited containers, this may also be a point of entry (such as, for example, a sluice or anteroom).

Release device—a valve, regulator, tap, membrane or any other device, assembly or structure that allows the release of a fluid from a Pressure Vessel; in most cases such a device is used for both filling the Pressure Vessel with a fluid and for releasing the fluid therefrom. A Release Device is normally situated in the end cap (or “head”) of a Pressure Vessel. For inhabited containers this may also be a point of exit (such as, for example, a sluice or anteroom).

Environment outside of Pressure Vessel (or Container)—Anything that is on the outside of the Pressure Vessel, such as, but not limited to, piping, valves and other devices placed outside of the Pressure Vessel for forwarding its contents further, or for filling the Pressure Vessel with a gas or other fluid or just venting the fluid to the external atmosphere if the contents of the Pressure Vessel are released directly into the external atmosphere.

Shell or External Shell—an external wall or wall structure of a Pressure Vessel or pipe.

### SUMMARY OF THE INVENTION

The principal objects of this invention are as follows:

The provision of a pressure vessel design that overcomes the above-described deficiencies in the prior art, especially in pressure vessels and cylinders where there may be a very great pressure differential between the internal and external pressures.

The provision of a manufacturing method that allows making pressure vessels of a unique design having an internal supportive structure.

The provision of a method for making vessels for fluid packaging and storage.

The provision of a method of making pressure vessels in one automated process, without, or with limited, human intervention.

The provision of a pressure vessel design that allows reducing pressure load on its walls by providing an internal supportive structure having bonds which support the walls of the pressure vessel.

The provision of an additive manufacturing method and process whereby a pressure vessel is fabricated by applying a layer-upon-layer technique using 3D printing, the manufacturing method comprising, but not limited to, Fused deposition modeling, Electron Beam Freeform Fabrication, Direct Metal Laser Sintering, Electron Beam Melting, Selective Laser Melting, Selective Heat Sintering, Selective Laser Sintering and other additive manufacturing methods.

The provision of an additive manufacturing method and process where a pressure vessel is made layer-by-layer using 3D printing techniques and materials comprising, but not limited to, a group of synthesized materials, ceramics, metal and metal alloys powders, thermoplastics, clays, graphene and carbon compositions, paper, foils and combinations or mixtures of them.

The inventive method utilizes Additive Manufacturing and/or 3D Printing technology that allows the creation of a unique design of a pressure vessel, cylinder or other container under positive or negative pressure, using an internal supportive structure that allows for the reduction of pressure applied to the walls of the Pressure Vessel and/or the application of counterbalancing pressures to those walls. This allows for the fabrication of such vessels or containers that are lighter and stronger that current industry product, using less material and without any waste.

For many decades the industry relied on the strength of the material used to construct a Pressure Vessel, and the thickness of the vessel walls since Pressure Vessels are held together against the gas pressure due to tensile forces within the walls of the vessel. The normal (tensile) stress in the walls of the vessel is proportional to the pressure and radius of the vessel and inversely proportional to the thickness of the walls.

Therefore, Pressure Vessels are designed to have a thickness proportional to the radius of the tank and the pressure of the tank and inversely proportional to the maximum allowed normal stress of the particular material used in the walls of the vessel.

Because (for a given pressure) the thickness of the walls scales with the radius of the tank, the mass of a tank (which scales as the length times radius times thickness of the wall for a cylindrical tank) scales with the volume of the gas held (which scales as length times radius squared).

The present invention provides a new approach to the design and manufacturing method of a Pressure Vessel, which allows for making it lighter, stronger and capable of withstanding much greater pressure differentials (whether it is the pressure within the vessel which is greater, or the pressure outside the vessel which is greater) than heretofore known. In this context, a “much greater” pressure differential is one which is at least 5 times, and, more preferably, at least 10 times greater than known pressure differentials for vessels made of similar materials and with similar construction. For example, a currently known container for holding liquefied natural gas made of reinforced steel may be capable of withstanding a pressure differential of 300 bar, while a vessel made in accordance with the inventive method and design may be capable of withstanding a pressure differential of 10,000 bar. It will also be appreciated by one of ordinary skill in the art that, simply because a vessel may be capable of withstanding such a great pressure differential does not require that the vessel be subjected to any pressure differential whatsoever. Again, by way of example only, essentially every vessel is manufactured in a zero-differential environment, and, even after construction, may not be subjected to a differential pressure environment for some time, if ever. Some vessels made in accordance with the invention may be used for containing fluids at a zero-differential pressure environment, such as holding gasoline in a passenger vehicle. However, these vessels may be capable of withstanding higher pressure differentials due to their construction compared with known fuel tanks, and can therefore be made lighter due to their improved construction.

It is a further object of the invention to provide a vessel for use in vehicles which run on stored hydrogen, methane or other gases that would be able to safely accommodate much larger volumes of fuel by increasing storage and/or pressure.

Other objects and features of the present invention will become apparent from the following detailed description considered in conjunction with the accompanying drawings. It is to be understood, however, that the drawings are designed solely for purposes of illustration and not as a definition of the limits of the invention, for which reference should be made to the appended claims. It should be further understood that the drawings are not necessarily drawn to scale and that, unless otherwise indicated, they are merely intended to conceptually illustrate the structures and procedures described herein.

### BRIEF DESCRIPTION OF THE DRAWINGS

FIG. 1 is a vertical cross-section of a preferred embodiment of the invention showing an internal supportive structure of a pressure vessel in the form of individual spokes;

FIG. 2 is a horizontal cross-section of the embodiment of FIG. 1;

FIG. 3 is a horizontal cross-section of a secondary embodiment of the inventive structure, where the internal supportive structure consists of a set of perforated disks connecting the outside shell with the central supporting element;

FIG. 4 is a vertical cross-section of the embodiment of FIG. 3;

FIG. 5 is a perspective view of a further embodiment of the internal supportive structure of the inventive structure;

FIG. 6 is a vertical cross-section of a still further embodiment of the inventive structure;

FIG. 7 is a top view of the embodiment of FIG. 6, in a cross-sectional partial cutout view;

FIG. 8a is a top view, similar to that of FIG. 7, in a cross-sectional partial cutout view of a similar embodiment having a cellular-type internal supportive structure;

FIG. 8b is a detail of an individual cell of the embodiment of FIG. 8a, shown in cross-section;

FIG. 9 is a still further embodiment of the invention in a cross-sectional partial cutout view;

FIG. 10 is a horizontal cross-section of another embodiment of the inventive structure, having a non-cylindrical external shape with an internal supportive structure; and

FIG. 11 is a perspective view of a section of a pipeline use for transporting fluids under pressure, manufactured in accordance with another embodiment of the invention.

### DETAILED DESCRIPTION OF THE PRESENTLY PREFERRED EMBODIMENTS

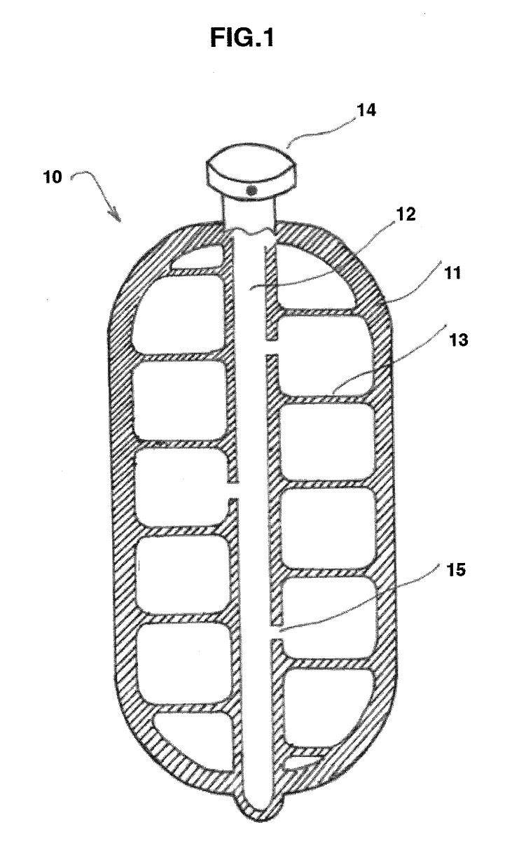

FIG. 1 shows a vertical cross-section of a first preferred embodiment 10 of the inventive pressure vessel. This embodiment comprises a generally cylindrical, hermetically sealed pressure vessel 10, having an external wall structure 11 and an internal supportive structure which includes a central supporting element 12 connected to wall 11 and bonds 13, which, in this embodiment, are in the form of spokes or traction rods. Bonds 13 perform an important function of transmitting the internal pressure forces applied to wall 11 to the central supporting element 12, which, in turn, transmits and distributes such pressure forces to the opposite side of the wall and vice versa. This allows vessel 10 to withhold much higher pressures as the same vessel made without such an internal supportive structure.

Bonds 13 can be distributed within vessel 10 either randomly or, in a preferred embodiment, using a configuration calculated to optimize force equalization within vessel 10. The embodiment of FIG. 1 shows one of many possible distribution arrangements of bonds 13 where all bonds 13 are attached to wall 11 in a winding or screw-like configuration like in spiral stairs. Any other distribution configurations of bonds 13 are possible so long as they allow the distribution of the internal pressure forces and/or reducing pressure stress on wall 11 as described above.

Central supporting element 12 can be of any shape, providing that it includes a cavity or an empty space inside therein that communicates with the internal environment of the vessel, e.g., via one or more holes or openings 15. This is necessary to allow for the filling of vessel 10 with a fluid and the release of the fluid stored in the interior of a vessel under pressure. For this purpose, a filling and/or release device, such as valve 14 or any other device with this functionality is positioned on one or both ends of central supporting element 12 allowing, when in use, a direct communication between the internal cavity of element 12 and the environment outside of vessel 10. Valve 14 can be made separately or integrally with vessel 10 during the 3D printing process. In some cases, a release valve can be situated on the top and a refilling valve on the bottom of element 12 or vice versa.

Central supporting element 12 is equipped with holes or openings 15 that allow communication with the internal environment of vessel 10. Holes 15 also allow filling vessel 10 with a gas or liquid and the release thereof. The size and number of such holes 15 may vary depending on the application and can conveniently be limited to a certain value in order to allow only a certain amount of the stored fluid to be released at a predetermined rate, which can be calculated in advance in known fashion in dependence upon the pressure of the fluid, its viscosity and the total cross-sectional area of all holes 15, inter alia. This is a very important feature of this invention since in many applications only a limited amount of fluid should exit vessel 10 during a given time interval, or in cases where a full discharge time is required by a standard, as in fire suppression cylinders (e.g., 60 sec.).

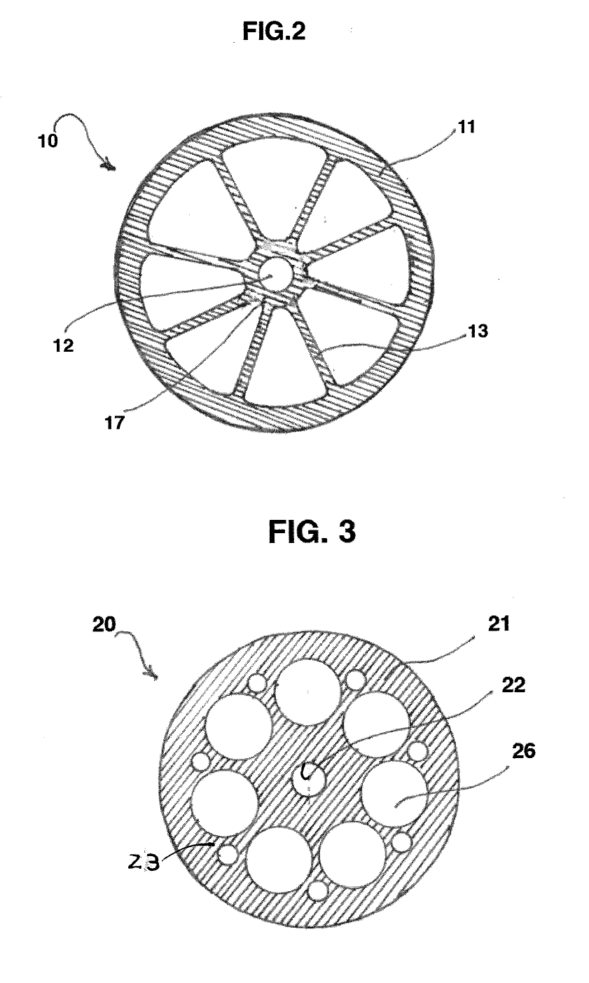

FIG. 2 shows schematically the same embodiment of hermetically sealed vessel 10 from FIG. 1 in a cross-sectional view. The number, size and thickness of bonds or spokes 13 can vary accordingly to the size, shape, material and operating pressure of vessel 10, in known fashion.

FIGS. 3 illustrates a cross-sectional view of a vessel 20 similar to that of vessel 10 shown in FIGS. 1 and 2, in which the internal supportive structure includes a set of perforated disks 23 connecting an exterior wall 21 with a central supporting element 22. In the cross-section through such a disk 23 we can see wall 21, the cavity of central supporting element 22 and perforations 26 that can be in any shape in order to save weight in the manufacture of vessel 20.

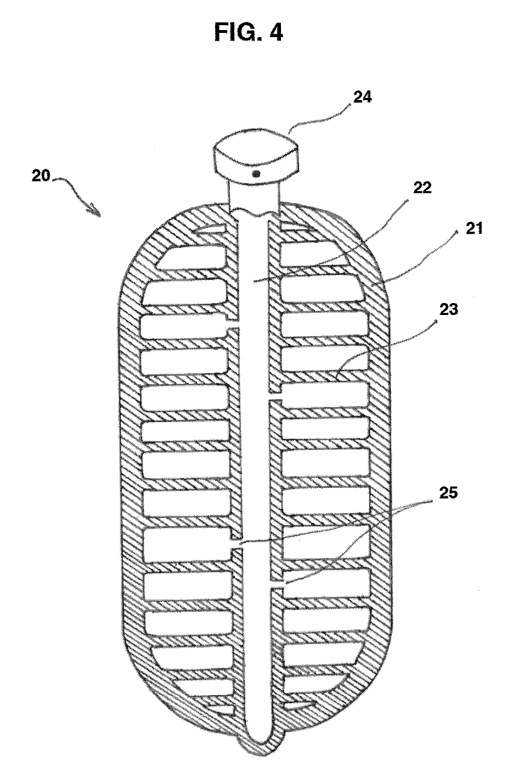

FIG. 4 shows the same embodiment 20 in a horizontal section. Here, we can better see wall 21, central supporting element 22, and disks 23, which play the role of bonds connecting central supporting element 22 with wall 21. Perforations 26 are omitted from FIG. 4 for ease of reference. A filling and release device, such as a valve 24 is situated on the top of vessel 20 communicating with central supporting element 22, which in turn, communicates with the interior of vessel 20 via holes 25.

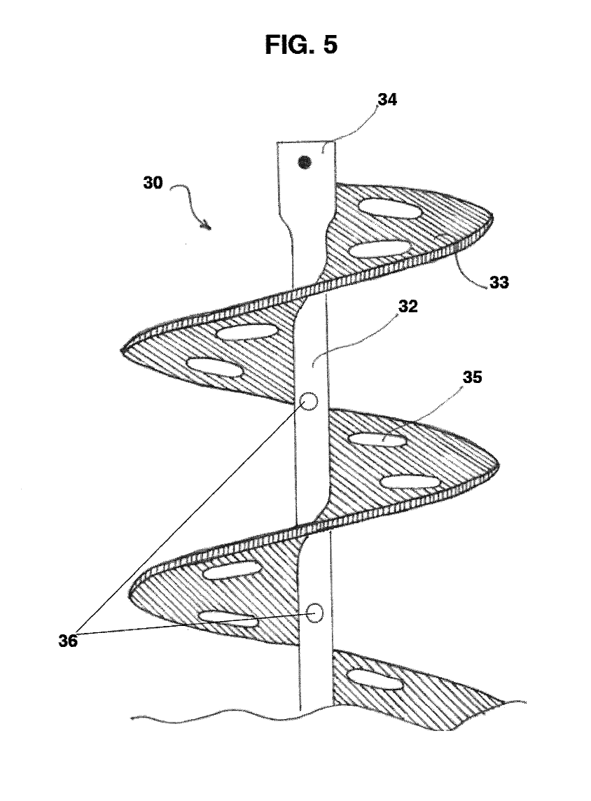

FIG. 5 illustrates another embodiment of an internal supportive structure 30 of a vessel, this embodiment having a screw-like shape with one or more bonds 33 providing strong ties between the airtight walls of the vessel (not shown here) and a central supporting element 32, which is connected to the exterior environment with a filling and release device 34. Bonds 33 are perforated with openings 35 and are attached to a wall of the vessel forming one strong body capable of withstanding high pressures. The internal space or cavity of the central supporting element 32 communicates with the interior of the vessel via holes 36, the number and flow capacity of which shall be calculated in advance according to the desired operating characteristics required for a given pressure vessel.

The embodiments shown in FIGS. 3, 4 and 5 can be made using 3D printing technique or conventional technologies, like filament wound process in composite vessels, where a use of graphene or graphene-based composites is strongly recommended.

The inventive concept allows making hermetically sealed or airtight vessels with internal positive pressure as well as external positive pressure, such as submarines and underwater structures, whether inhabitable or industrial.

Manufacturing of such pressure vessels using conventional technologies adopted by the industry would be very difficult. However, additive manufacturing, better known as 3D printing allows making such vessels without the problems associated with most current technologies and without the waste of construction materials.

There are various 3D printing techniques that can be used for manufacturing such vessels with the inventive design concept of the internal supportive structure, such as:
Fused deposition modeling (FDM)
Electron Beam Freeform Fabrication (EBF)
Direct Metal Laser Sintering (DMLS)
Electron Beam Melting (EBM)
Selective Laser Melting (SLM)
Selective Heat Sintering (SHS)
Selective Laser Sintering (SLS)
Other Additive Manufacturing Techniques

Most of these techniques are suitable for the manufacturing of the inventive pressure vessels. They allow for the manufacture of the end product from a single material and/or multiple materials. Extrusion (FDM), Wire (EBF) and Granulate (DMLS, EBM, SLM, SHS and SLS) based manufacturing processes are most preferable for this invention.

Using these techniques, the whole vessel may be made in one process, without direct human intervention or any waste materials. Moreover, the walls of a vessel can be made either solid or having a cell structure for reducing the total weight of the product, depending upon the application. Such a cell structure can be of any shape that maintains the overall strength of the wall, e.g., a honeycomb structure.

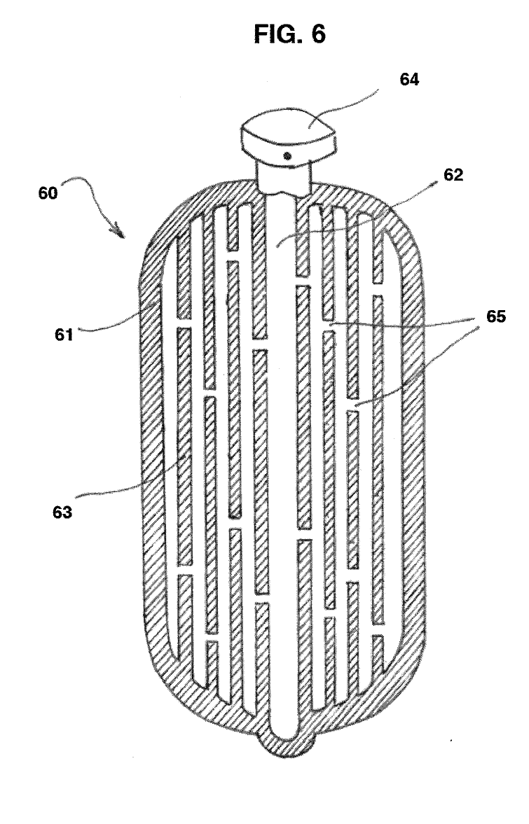

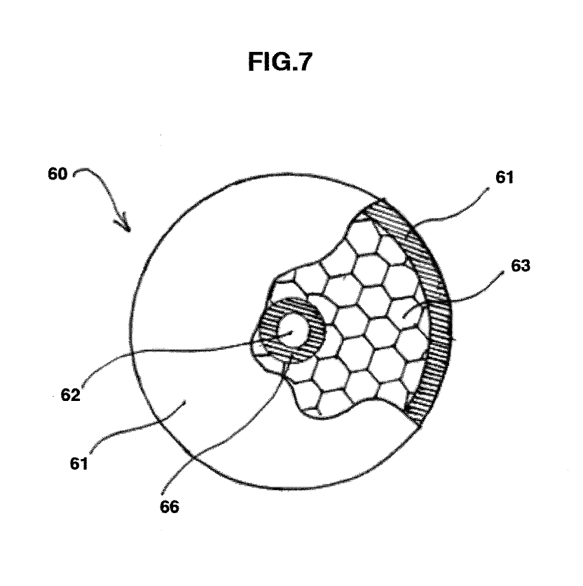

Using this idea, we introduce the most preferred embodiment shown in FIGS. 6 through 10, where, instead of the spokes or bonds of FIGS. 1 through 5 (13, 23 and 33), we can see a plurality of honeycomb-like bond structures (63, 73, 93 and 103) that fill essentially the entire internal volume of the vessel (60, 70, 90 and 100). In this case, the central supporting element (62, 72, 92 and 102) can also have a honeycomb-like shape in its cross-section with a central hole or cavity inside (see, e.g., FIG. 7). In the drawings, such central supporting elements are shown differently from other cells of the bond structures (63, 73, 93 and 103) simply in order to distinguish them schematically. In each embodiment, the central supporting element (62, 72, 92 and 102) can be just another cell of the cellular bond structure with its only distinguishing characteristic being that it communicates directly with the filling and release device (64, 74 and 94). Intercellular holes 65 (visible only in FIG. 6, but present in the other embodiments) allow communication between each cell and the central supporting element.

All structural cells of the bond structure (63, 73, 93 and 103) must have some holes between them for communicating with each other and central supporting element (62, 72, 92 and 102) in order to allow filling the vessel (60, 70, 90 and 100) with a fluid and releasing it when needed via valve (64, 74 and 94) situated on one or both ends of the central supporting element (62, 72, 92 and 102). The structural cells of the bond structure (63, 73, 93 and 103) may have any possible shape that will allow for the effective transmission of the pressure forces applied to the external shell of the vessel (60, 70, 90 and 100) onto the central supporting element (62, 72, 92 and 102) and between the cells. Preferred structures are tubes or polyhedrons having triangular, square, pentagonal, hexagonal, etc. cross-sections. The central supporting element (62, 72, 92 and 102) of each embodiment can be the same as other cells with the only difference being that its internal cavity can communicate with its respective filling and release device(s) (64, 74 and 94). The opening shown inside central supporting elements (62, 72, 92 and 102) is provided only schematically and does not need to be different from the cross-section of the other cells in the vessel, which in turn can be made different within the same vessel, which is easy to accomplish using 3D printing techniques.

The biggest advantage of this design of a vessel (60, 70, 90 and 100) is the reduced risk of an explosion resulting from external damage to the vessel compared to the design of known pressure vessels. Should the external shell of the pressure vessel be damaged by a bullet or other mechanical means, then only one or a few cells will release their contents instantly, but most of the stored fluid will be released with a controlled speed. This is achieved due to reduced flow capacity of the holes through which each cell communicates with each other and the central supporting element. The number and size of these communication holes, as well as the number and size of the cells themselves can be calculated during the design process according to any needed release and filling time of a pressure vessel and the desired safety level. Most pressure vessels do not need fast fluid release, like fuel tanks of the vehicles using gases. Such fuel vessels shall have an increased number of cells of the internal supportive structure and a reduced number and/or flow capacity of the intercellular holes or openings between the cells which greatly increases the safety of such vessels.

Therefore, this design concept using honeycomb-like bond structures (63, 73, 93 and 103) is most suitable for high-pressure gas or liquid storage, especially in fuel tanks in aircraft and automobiles (e.g., those fueled by methane or hydrogen), etc. Moreover, the fact that the surface area of the interior cells is many multiples of the surface area of the vessel's external shell will also considerably reduce the pressure stress on the external shell of the vessel having such an internal supportive structure. This will allow holding fluids at much higher pressures than would be the case in vessels without internal supportive structure.

Attention is now specifically directed to FIG. 7, which illustrates schematically a cross-sectional partial cutout of a vessel 60.

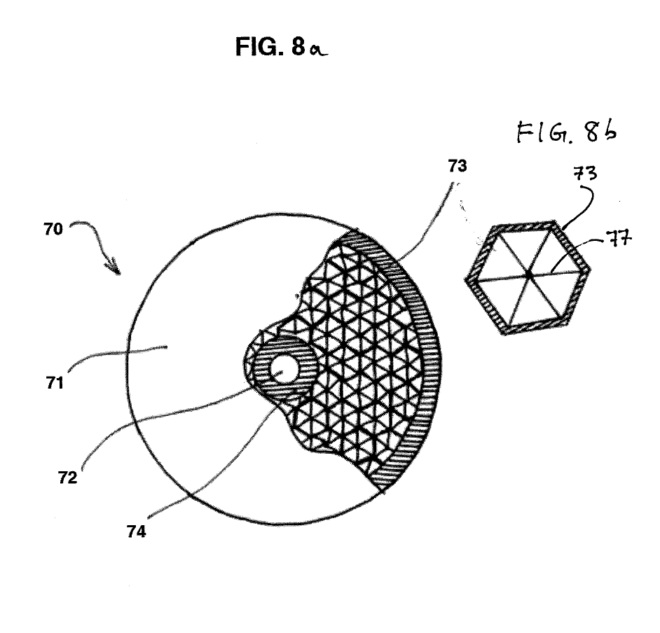

FIG. 8a shows a cross-sectional partial cutout of a vessel 70, which is similar to vessel 60, only having different cell structure 73 providing a firm connection between walls 71 and central supporting element 74 having an internal cavity 72. FIG. 8b shows a detailed cross-section of an individual cell 73 having its own bonds and supports 77 therein.

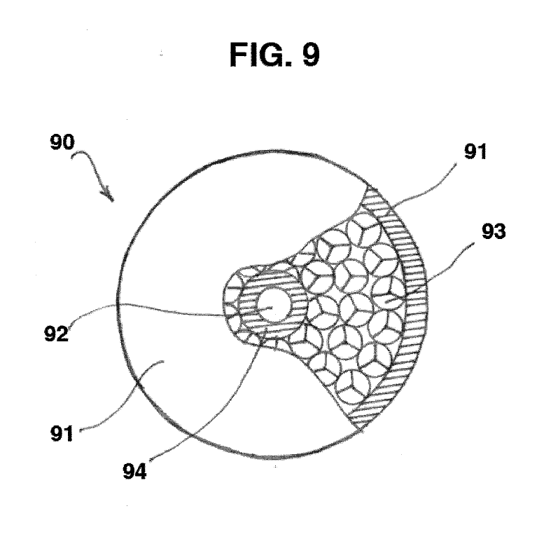

FIG. 9 illustrates a cross-sectional partial cutout of a vessel 90, which is similar to vessels 60 and 70, only having different cell structure 93 providing a firm connection between walls 91 and a central supporting element 94 having an internal cavity 92.

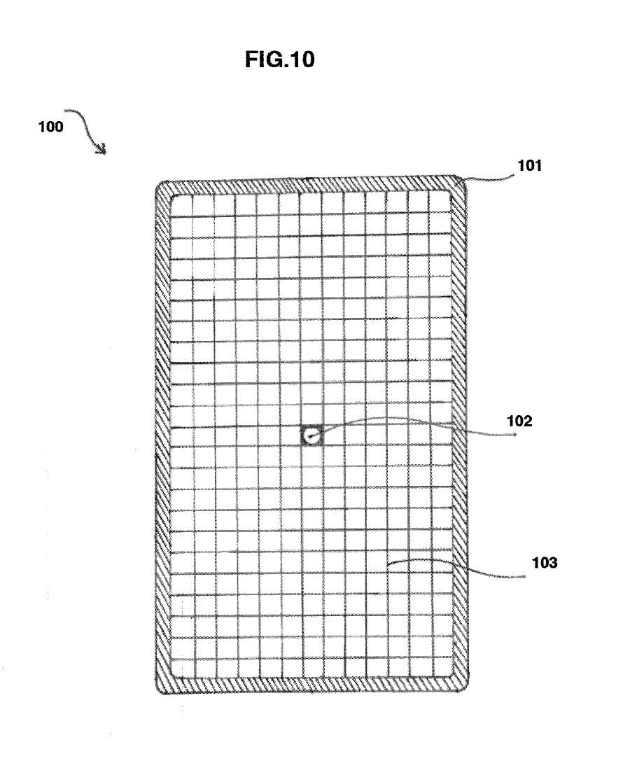

FIG. 10 illustrates schematically a cross-sectional partial cutout of a vessel 100, which is similar to vessels 60, 70 and 90, only having a different cell structure 103 providing a firm connection between walls 101 and a central supporting element 102.

Suitable materials for the manufacturing of the various inventive pressure vessels are metals and metal alloys, synthesized materials, silicones, clays, graphene, porcelain, foils and paper, and any other materials that can be used in Additive Manufacturing processes. These materials can be provided to the manufacturing process in the form of a powder, in liquid or molten form, or dissolved and synthesized during the 3D printing process, as well as any other form that can be used in additive manufacturing. Most suitable are synthesized materials, ceramics, metal and metal alloys powders, composites, thermoplastics, clays, graphene and carbon compositions, paper, foils and combinations or mixtures of them.

Powders containing titanium and its alloys, cobalt chrome alloys, stainless steel, aluminum and ceramics are most preferable for manufacturing the inventive pressure vessels.

Graphene and composites based on graphene are 200 times stronger than steel, therefore they are perfectly suited for making high pressure vessels and specifically for the external shell or wall of such a vessel, its internal structure or just a supporting part of such a shell.

The inventive method of manufacturing allows the manufacture of such vessels from computer aided design (CAD) using computer aided manufacturing (CAM), which enables producing a product of such complex shape in one piece, layer by layer, until complete.

The release and/or refilling device (14, 24, 34, 64, 74 and 94) can be made on one end or both ends of the central supporting element (12, 22, 32, 66, 74, 94 and 102), e.g., one for release and one for filling. Such devices can be made in one 3D printing process together with the vessel or can be made separately and attached to the central supporting element using a threaded connection, adhesives and any other connection techniques suitable for a particular application and pressure. The central supporting element selectively communicates with the environment outside of the vessel when filling and/or release device is initiated for a filling or release. This environment outside of the vessel can include, without limitation: piping, valves and other devices placed outside of the vessel for forwarding the released fluid further in a system or filling it with a gas or other fluid. In some cases, the environment outside of the vessel can be just the external atmosphere if the content of the vessel has to be, or may be, released directly into it.

All embodiments show that the shape of the supporting structure inside of a vessel can vary in many ways as long as it fulfills the main requirement of this invention—distribution of the pressure forces applied to the external shell of the vessel to the central supporting element, which in turn distributes these forces further to the external shell, thus reducing the overall pressure load on the shell (or walls) of the vessel.

The cellular design of the internal supportive structure allows for the considerable reduction of the pressure load on the external wall structure of any pressure vessel or container by transmitting and distributing at least a part of that load onto walls within the cellular structure. Also, a part of this pressure load will be transmitted onto other parts of the wall structure, which effectively cancels at least a part of this load and allows the external wall structure to accommodate a much higher pressure than without said internal supportive structure.

This allows making much stronger and lighter vessels or containers that can withstand much higher pressures than similar vessels without such internal supportive structure. The bonds and especially the walls of the cellular structure in all embodiments can have any thickness from 1 atom (by graphene) to many millimeters or more depending on the size of a desired vessel and the application in which it will be used.

The inventive method of manufacturing such vessels with an internal supportive structure, not limited to those shown in the above embodiments, allows making the complex structures of the vessels in one fabrication session using 3D printing techniques. A 3D printer, using computer aided design, can make any such vessel by printing it, layer-by-layer, from one end to another, using suitable materials described above whether in the form of a powder, paste, clay, etc. The technique of 3D printing is known to those skilled in the art and is not a subject of this invention, per se.

Some of the inventive design configurations, such as those shown in embodiments 20 and 30 can be made using conventional techniques adopted by the industry, such as Filament Wound Composite technique and some similar methods. In this case, the internal supportive structure consisting of the central supporting element (22 and 32) and bonds (23 and 33), can be made separately using a metal or other material and further being attached to the external shell using conventional filament winding machines working with carbon fiber or other fiber material. Here, it is necessary to establish firm connections between the bonds (23 and 33) and the external shell of a vessel, which can be done using many conventional techniques and materials. A use of graphene or graphene-based composites is strongly recommended. Graphene can also be used for making at least a part of the internal supportive structure, which can have bonds as thin as 1 atom.

The embodiments containing cellular bond structure (e.g., 60, 70, 90 and 100) will have a very high safety level, since such designs will prevent the rupture of the vessel due to high pressure and/or temperature and mechanical damage from outside. Such damage (e.g., from a riffle bullet) will only permit the fast release of a gas from one or a few cells while slowing the release of the gas from all other cells thereby preventing the catastrophic or explosive rupture of the vessel. This important feature can prevent the many fatal accidents occurring every year resulting from damage to pressure vessels worldwide.

The invention presented above also applies to human inhabitable or visited containers, such as underwater stations and vehicles that operate at a higher outside pressure; as well as aircraft and space vehicles, space and interplanetary stations that might have higher pressures inside than outside. The interplanetary stations and other habitats may have both, increased or reduced ambient atmospheric pressures.

Cellular supporting structures such as those shown in FIGS. 6 through 10, can also be used in the production of pressurized pipes for transporting gas, oil, water and other fluids. Such pipelines would be much stronger and safer than those heretofore known, since in the case of external damage, most of the cells would stay intact, which will prevent catastrophic destruction of the pipe, explosions, etc. In such a case, the outgoing flow of the fluid under pressure will be controlled by the fact that the fluid will have to flow through the various openings between the cells or other internal supportive structure in order to reach the environment outside the vessel.

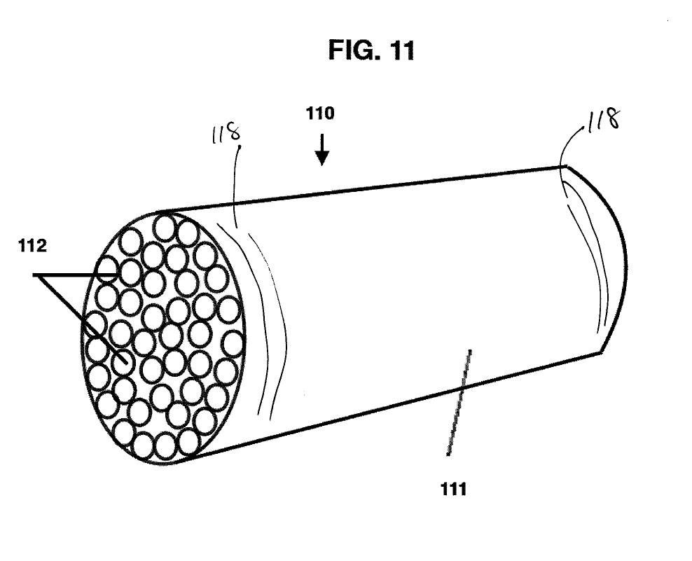

Another use of the inventive vessel is shown in FIG. 11 which illustrates schematically a segment 110 of a pipeline having tubular cells inside. In such pipelines the single cells shall extend the length of the whole piping and the number of the communication openings (not shown) between single cells can be greatly reduced or even eliminated. Most safe pipelines shall be designed using cell structure where single pipe cells do not communicate with each other at all. During assembly of such pipes into pipelines, every single cell must be connected with a corresponding cell in the next section of pipe. The segment may be joined to adjacent segments of the pipeline, or to the supply of the fluid or the ultimate receiver of the fluid by means of connectors 118 which in a preferred embodiment are complimentary to one another, such as threads, so that successive segments 110 may be conveniently attached to one another in succession to build a pipeline of the desired length.

The single segment's internal cellular supporting structure 112 can either have strong bonds for supporting each other and the external shell 111 of segment 110 or can be incorporated into supporting disks similar to those shown in FIG. 3 as disk 21. Such disk would hold all single pipe cells in place for easy assembly into a pipeline and would provide strong support for the external wall of pipe 100. In this design, the disks should be perforated to allow the fluid to be transported also around the cells 112 to avoid unnecessary restriction of the flow capacity of the pipeline.

There can be two variations of the cell structure—the cells that have cavities that are communicating with the interior of a pipe or pipeline and the cells that are not communicating with the interior of a pipe segment or pipeline.

However, the best method of making such pipelines is to make them on location using a mobile 3D printer. Such a printer would produce external and internal structures similar to those described above, using the same materials and techniques and do so continuously on demand.

If such a pipeline, transporting for instance natural gas under pressure, is damaged then only damaged cells will start leaking their content, but other cells will continue in use. Repairing such a pipe would be also much easier, as well as containing and fighting fires resulting from such damage.

The walls of every single cell should be made as thin as possible, consistent with the operating parameters, for functioning as a supportive structure in order to keep the weight of the individual pipe segments down, which is possible since the external wall of the segment can be also made thinner since it has an internal supportive structure.

Moreover such pipes can be made from non-corrosive materials, which can greatly extend their life of use. For instance a pipe made from a ceramic using 3D printing can maintain a perfect condition in the ground or underwater for hundreds of years at least.

Car manufacturers and users would greatly benefit from this design as well, since pressurized fuel tanks would be much safer and can be made in any possible shape to fit into available space inside of a car body. This applies to all other vehicles, aircraft and space installations.

While there have been shown and described and pointed out fundamental novel features of the invention as applied to the described embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

What is claimed is:

1. A method of making a vessel for holding fluid at a pressure substantially different from the ambient pressure, said method comprising:
providing a hermetically sealed external wall structure having at least one opening for acting as at least one of a filling device and a release device; and
providing at least one supporting bond within said external wall structure for supporting said external wall structure, said at least one supporting bond being positioned to perform at least one of the functions of distributing and reducing pressure forces applied to said external wall structure;
whereby the provision of said at least one supportive bond inside the vessel provides a strong connection between walls of the vessel, which allows the vessel to be exposed to a much greater pressure differential with the ambient pressure than the same vessel without said at least one supporting bond would be able to accommodate.

2. The method of claim 1, wherein said at least one opening is a valve.

3. The method of claim 1, wherein at least one of said external wall structure and said at least one supporting bond is fabricated using an additive manufacturing technique.

4. The method of claim 3, wherein said additive manufacturing technique is selected from the group consisting of: Fused Deposition Modeling; Electron Beam Freeform Fabrication; Direct Metal Laser Sintering: Electron Beam Melting: Selective Laser Melting: Selective Heat Sintering; and Selective Laser Sintering.

5. The method of claim 3, wherein the vessel is formed of one or more materials selected from the group consisting of: synthesized materials, ceramics, metal and metal alloy powders;
thermoplastics; clays; graphene; carbon compositions; paper; and foils.

6. The method of claim 5, wherein said at least one supporting bond is made layer-upon-layer together with said external structure during a single 3D printing process.

7. The method of claim 1, wherein said at least one supporting bond has a shape selected from the group consisting of: spokes, strings, needles, chains, disks, plates, rods, screw-shaped and complex profiled structures, tubes, polyhedrons, cells in the form of polyhedron tubes, cellular structures, and honeycomb-like internal supportive structures.

8. The method of claim 1, further comprising the step of:
providing a central supporting element within said exterior wall structure of the vessel, said central supporting element having a cavity and at least one opening for permitting fluid communication between said cavity and the interior of the vessel;
wherein said at least one supporting bond has a first part connected to an exterior of said central supporting element and a second part connected to an interior side of said external wall structure.

9. The method of claim 8,
wherein said at least one opening is a valve; and
wherein said central supporting element includes a first end at which said valve is in fluid communication with said cavity, and said central supporting element extends into the interior of the vessel from said first end thereof.

10. The method of claim 9, wherein said valve is a first valve and the method further comprises the steps of:
forming a second valve in the vessel; and
forming said central supporting element so that said cavity allows communication with both said first valve and said second valve;
wherein one of said first and second valves permits only one of filling the vessel with the fluid and releasing the fluid from the vessel, and the other of said first and second valves permits only the other of filling the vessel with the fluid and releasing the fluid from the vessel.

11. The method of claim 8, wherein said cavity is formed so as to selectively communicate with the environment outside of the vessel during at least one of the filling and release processes.

12. The method of claim 8, further comprising the step of:
forming an internal supportive structure having cells within the vessel;
wherein said cavity is formed as part of said internal supportive structure; and
wherein said cavity is also formed so as to permit communication with the environment inside said cells of said internal supportive structure.

13. The method of claim 12, wherein said central supporting element is one of said cells of said internal supportive structure.

14. The method of claim 1, further comprising the steps of:
forming said at least one bond as a plurality of substantially enclosed cells, each of said cells having at least one opening for communicating with an adjacent one of said plurality of cells; and
providing at least one central supporting element having a cavity and at least one opening for permitting fluid communication between the interior of the vessel and said cavity;
wherein said central supporting element is formed as one of said cells; and
wherein said at least one opening in said central supporting element and said at least one opening in said cells facilitate the flow of the fluid within the vessel.

15. The method of claim 1, wherein the vessel is integrally made in a single 3D printing process.

16. The method of claim 1 wherein said external wall structure is produced in more than one part and then assembled.

17. The method of claim 16, wherein at least one of said more than one part of said external wall structure is produced using filament winding technology

18. The method of claim 2, further comprising the step of:
forming said at least one valve separately for assembly in the vessel.

19. The method of claim 1, wherein the vessel is at least partially made of a graphene-based material.

20. The method of claim 1, wherein the vessel is a segment of a pipeline for transporting the fluid.

21. The method of claim 1,
wherein the vessel is sized to accommodate an object in addition to the fluid; and
wherein the method further comprises the step of:
forming an opening in said external wall structure sized to allow the passage of the object therethrough.

22. A method of making a segment of a pipeline for transporting fluid under pressure, the segment having a generally cylindrical shape and first and second open ends, the method comprising:
forming a hermetically sealed external wall structure;
forming an internal supportive structure within said wall structure, said internal supportive structure including a plurality of cells which extend between the first open end of the segment and the second open end thereof, said cells being formed to carry the fluid as it is transported through the segment and to provide support to the wall structure to distribute the pressure differential between the fluid and the ambient pressure being exerted on the exterior of said wall structure;
forming a first connection mechanism on the first open end of the segment configured to couple the segment to one of a supply for the fluid and an adjacent pipe segment; and
forming a second connection mechanism on the second open end of the segment configured to couple the segment to one of a receiver for the fluid and an adjacent pipe segment;
whereby the provision of said internal supportive structure inside the segment supports said wall structure, which allows the segment to be exposed to a much greater pressure differential with the ambient pressure than the same segment without said internal supportive structure would be able to accommodate.

23. The method of claim 22, wherein at least one of said external wall structure and said internal supportive structure is fabricated using an additive manufacturing technique.

24. The method of claim 22, wherein said internal supportive structure is made layer-upon-layer together with said external wall structure during a single additive manufacturing process.

25. The method of claim 22, wherein said additive manufacturing technique is selected from the group consisting of: Fused Deposition Modeling; Electron Beam Freeform Fabrication; Direct Metal Laser Sintering: Electron Beam Melting: Selective Laser Melting: Selective Heat Sintering; and Selective Laser Sintering.

26. The method of claim 22, wherein the segment is formed of one or more materials selected from the group consisting of: synthesized materials, ceramics, metal and metal alloy powders; thermoplastics; clays; graphene; carbon compositions; paper; and foils.

27. The method of claim 26, wherein the segment is made at least partially from a flexible material.

28. The method of claim 22, wherein said internal supportive structure includes a plurality of supporting bonds, each of said supporting bonds having a shape selected from the group consisting of: spokes, strings, needles, chains, disks, plates, rods, screw-shaped and complex profiled structures, cells formed as substantially round tubes, cells formed as polyhedron tubes, cellular structures, and honeycomb-like internal supportive structures.

29. The method of claim 28, wherein said supporting bonds are formed as cells, and said cells are sealed so as to preclude fluid communication therebetween.

30. The method of claim 28, wherein said supporting bonds are formed as cells, and said cells include openings which permit fluid communication therebetween.

31. The method of claim 22, wherein said first and second connecting means are complementary.

32. A method of producing a vessel for holding fluid at a pressure substantially different from the ambient pressure, said method comprising:
printing, layer-upon-layer via 3D printing, a hermetically sealed external wall structure having at least one valve for acting as at least one of a filling device and a releasing device;
forming, in a single printing process, an internal supportive structure within said external wall structure for supporting said external wall structure via supporting bonds for distributing and reducing pressure forces applied to said external wall structure, said internal supportive structure having at least one central supporting element;
forming a cavity within said central supporting element, said cavity communicating with the interior of the vessel and selectively communicating with an environment outside of the vessel during at least one of the filling and release processes.

33. A pressure vessel for holding a fluid at a pressure substantially different from the ambient pressure, the vessel comprising:
a hermetically sealed external wall structure having at least one opening for acting as at least one of a filling device and a releasing device; and
at least one supporting bond for supporting said external wall structure, said at least one supporting bond being connected to at least first and second portions of the interior of said external wall structure;
whereby said at least one supporting bond reduces pressure forces applied on said first portion of said external wall structure by distributing said pressure forces to at least said second portion of said external wall structure.

34. A pressure vessel for holding fluid at a pressure substantially different from the ambient pressure, the vessel comprising:
a hermetically sealed external wall structure having at least one opening for acting as at least one of a filling device and a releasing device;
a central supporting element having an internal cavity which communicates with the interior of the vessel and selectively communicates with an environment outside of the vessel through said opening; and
at least one supporting bond for supporting said external wall structure, said at least one supporting bond being connected to the interior of said external wall structure and to said central supporting element;
whereby said at least one supporting bond reduces pressure forces applied on a first portion of said external wall structure by distributing said pressure forces through said central supporting element to a second portion of said external wall structure.

35. The pressure vessel of claim 34, wherein said at least one opening is a valve.

36. The pressure vessel of claim 34, wherein the vessel is integrally formed, with said external wall structure and said at least one supporting bond being made integrally as a single piece.

37. The pressure vessel of claim 34, wherein
the vessel is fabricated from one or more materials selected from the group consisting of: synthesized materials, ceramics, metal and metal alloy powders, thermoplastics, clays, graphene and carbon compositions, paper, and foils.

38. The pressure vessel of claim 34, wherein
said at least one supporting bond is formed in a shape selected from the group consisting of: spokes, strings, needles, chains, disks, plates, rods, screw-shaped, complex profiled structures, tubes, polyhedrons, cells in a form of tubes or polyhedrons, complex cellular structures, honeycomb-like internal supportive structures.

39. The pressure vessel of claim 34, wherein said external wall structure is formed separately from said at least one supporting bond, and is positioned about said at least one supporting bond.

40. The pressure vessel of claim 34, wherein said external wall structure is at least partially formed of a wound composite filament.

41. The pressure vessel of claim 37, wherein said external wall structure is at least partially fabricated of graphene.

42. The pressure vessel of claim 34,
wherein the vessel is configured for use in a vehicle; and
wherein said external wall structure is configured to fit into a predetermined location within the vehicle.

43. The pressure vessel of claim 34,
wherein the pressure vessel is configured to receive one or more objects in addition to the fluid; and
wherein the pressure vessel includes a sealable opening for allowing passage of said one or more objects into the vessel.

44. The pressure vessel of claim 43, wherein said opening includes a valve.

45. The pressure vessel of claim 43, wherein the vessel further comprises at least one valve, and said opening is separate from said valve.

46. The pressure vessel of claim 34,
wherein the vessel is a segment of a pipeline for transporting the fluid;
wherein said external wall structure includes a first open end and a second open end; and
wherein the vessel further comprises:
a first connector positioned about said first open end to connect the segment to one of an adjacent segment of the pipeline and a source for the fluid; and
a second connector positioned about said second open end to connect the segment to one of an adjacent segment of the pipeline and a receiver for the fluid.

47. A segment of a pipeline for transporting fluid at a pressure substantially different from the ambient pressure, the segment comprising:
a generally cylindrical hermetically sealed external wall structure, having open first and second ends;
an internal supportive structure for supporting said wall structure against a pressure differential between the pressure of the fluid and the ambient pressure; and
whereby said internal supportive structure reduces pressure forces applied on a first portion of said external wall structure by distributing said pressure forces through said internal supportive structure to a second portion of said external wall structure.

48. The segment of claim 47, further comprising:
a first connection mechanism disposed at said first open end, for connecting the segment to one of a source for the fluid and an adjacent segment of the pipeline; and
a second connection mechanism disposed at the second open end, for connecting the segment to one of a receiver for the fluid and an adjacent segment of the pipeline.

49. The segment of claim 48, wherein said first and second connection mechanisms are complementary.

50. The segment of claim 47, wherein the segment is formed of one or more materials selected from the group consisting of: synthesized materials, ceramics, metal and metal alloy powders; thermoplastics; clays; graphene; carbon compositions; paper; and foils.

51. The segment of claim 50, wherein the segment is made at least partially from a flexible material.

52. The segment of claim 47, wherein said internal supportive structure includes a plurality of supporting bonds, each of said supporting bonds having a shape selected from the group consisting of: spokes, strings, needles, chains, disks, plates, rods, screw-shaped and complex profiled structures, cells formed as substantially round tubes, cells formed as polyhedron tubes, cellular structures, and honeycomb-like internal supportive structures.

53. The segment of claim 52, wherein said supporting bonds are formed as cells, and said cells are sealed so as to preclude fluid communication therebetween.

54. The segment of claim 52, wherein said supporting bonds are formed as cells, and said cells include openings which permit fluid communication therebetween.
